(19) United States
(12) Patent Application Publication
(10) Pub. No.: US 2026/0188949 A1
(43) Pub. Date: Jul. 2, 2026

(54) FLOATING CONNECTOR

(71) Applicant: CVILUX CORPORATION, New Taipei City (TW)

(72) Inventors: Wun-Sing Huang, New Taipei City (TW); Jhih-Ciang Wang, New Taipei City (TW)

(21) Appl. No.: 19/002,580

(22) Filed: Dec. 26, 2024

(51) Int. Cl. H01R 13/631; H01R 43/20; H01R 43/26

(52) U.S. Cl. CPC H01R 13/6315; H01R 43/20; H01R 43/26

(57) ABSTRACT

A floating connector contains: a male part, a female part, at least one flexible terminal, and at least one fixing portion. The male part includes at least one insert terminal and two fixed terminals. The female part includes a receiving portion and a surround portion, the receiving portion has a guide groove which is tilted and is formed at the receiving portion, a recessed portion, and at least one accommodation trench. The surround portion is rectangular and a size of the surround portion is greater than a size of the receiving portion. The surround portion has a rectangular orifice defined on a middle thereof, at least one accommodation trench formed on two long sides of the surround portion, and at least one trough defined on two short sides of the surround portion.

### TECHNICAL FIELD

The present invention relates to a floating connector, and more particularly to a floating connector and a method of connecting the same.

### BACKGROUND

A conventional electrical connector structure is designed to be used as a connecting component and ancillary accessories for electronic signals and power. Its main function is to provide electrical connections between various electronic devices or equipment to ensure signals are accurately transmitted. For connectors, in order to maintain transmission quality, a good match must be achieved between the connector and the transmission terminals.

In the current technology, the disadvantage of the connector is that the connection between the terminal and the connector is unstable. As long as the contact position is slightly deviated due to shaking or other conditions, the efficiency and stability of the transmission will be affected.

The present invention has arisen to mitigate and/or obviate the afore-described disadvantages.

### SUMMARY

The primary aspect of the present invention is to provide a floating connector and a method of connecting the same which allow a dislocation space among a male part, a female part and at least one flexible terminal to avoid a short cut during a movement, and the floating connector is replaceable easily to save a connection process and cost and to enhance a transmission efficiency and stability.

To obtain above-mentioned aspect, a floating connector provided by the present invention contains: a male part, a female part, at least one flexible terminal, and at least one fixing portion.

The male part includes at least one insert terminal connected on a central portion thereof, and the male part includes two fixed terminals connected on two sides of the male part.

The female part includes a receiving portion and a surround portion, the receiving portion is rectangular and has a guide groove which is tilted and is formed at a predetermined position of the receiving portion, a recessed portion defined on a predetermined position of a middle of the receiving portion, and at least one accommodation trench formed on a long side of two long sides of the receiving portion. The surround portion is rectangular and a size of the surround portion is greater than a size of the receiving portion, the surround portion has a rectangular orifice defined on a middle thereof, and the surround portion has at least one accommodation trench formed on two long sides of the surround portion, and at least one trough defined on two short sides of the surround portion.

The receiving portion is located at the rectangular orifice of the surround portion, the at least one accommodation trench of the receiving portion corresponds to the at least one accommodation trench of the surround portion, and a number of the at least one accommodation trench of the receiving portion is identical to a number of the at least one accommodation trench of the surround portion.

Each of the at least one flexible terminal includes a conduct segment formed on an end of each flexible terminal, a ground segment formed on the other end of each flexible terminal, at least one bent section, and at least one contact section formed at a predetermined position of each flexible terminal.

Each flexible terminal is received in the female part, each accommodation trench of the receiving portion and each accommodation trench of the surround portion, and the conduct segment of each flexible terminal is accommodated in the recessed portion of the receiving portion, and the ground segment protrudes out of the surround portion. The male part is inserted into the female part, each insert terminal of the male part is electrically connected with the at least one contact section of each flexible terminal, and each fixing portion is received in each trough of the female part.

Preferably, each insert terminal of the male part has a first coupling section and a second coupling section which are connected with the at least one contact section of the female part to produce a three-point contact.

Preferably, the guide groove of the female part is defined at a predetermined position of an X axis and a Y axis of the female part.

Preferably, the receiving portion of the female part has a material cut platform formed on a bottom of the receiving portion.

Preferably, a number of the guide groove of the female part is plural.

Preferably, each flexible terminal includes a dislocation section two engagement tabs extending from two side of each flexible terminal to enhance a fixing effect among the at least one accommodation trench of the surround portion of the female part.

Preferably, each flexible terminal includes a dislocation section formed at a predetermined position thereof.

Preferably, the dislocation section of each flexible terminal is in a U shape or the dislocation section of each flexible terminal is tilted and has a higher inner wall and a low outer wall.

Preferably, each fixing portion is formed in a sheet shape.

A method of connecting the floating connector has steps of:
(a) connecting a conduct segment and a ground segment of each flexible terminal of at least one flexible terminal with a material strap and then accommodating the conduct segment and the ground segment in a receiving portion of a female part;
(b) pushing the material strap of the conduct segment by using a material cut platform of a bottom of the receiving portion, when the conduct segment of each flexible terminal is accommodated at least one accommodation trench of the receiving portion;
(c) accommodating each flexible terminal in the receiving portion by using the step (b);
(d) putting at least one fixing portion in each trough of a surround portion of the female part;
(e) putting the receiving portion in a rectangular orifice of the surround portion, putting each flexible terminal in the at least one accommodation trench of the surround portion, and removing the material strap of the ground segment of each flexible terminal; and
(f) putting a male part on the female part and connecting at least one insert terminal of the male part with the contact segment of each flexible terminal.

### BRIEF DESCRIPTION OF THE DRAWINGS

FIG. 1 is a perspective view showing the assembly of a floating connector according to a preferred embodiment of the present invention.

FIG. 2 is a perspective view showing the exploded components of the floating connector according to the preferred embodiment of the present invention.

FIG. 3 is a cross sectional view showing the operation of the floating connector according to the preferred embodiment of the present invention.

FIG. 4 is another cross sectional view showing the operation of the floating connector according to the preferred embodiment of the present invention.

FIG. 5 is also another cross sectional view showing the operation of the floating connector according to the preferred embodiment of the present invention.

FIG. 6 is still another cross sectional view showing the operation of the floating connector according to the preferred embodiment of the present invention.

FIG. 7 is a perspective view showing the assembly of a floating connector according to another preferred embodiment of the present invention.

FIG. 8 is a cross sectional view showing the operation of the floating connector according to another preferred embodiment of the present invention.

FIG. 9 is a perspective view showing the assembly of a flexible terminal of the floating connector according to the preferred embodiment of the present invention.

FIG. 10 is another perspective view showing the assembly of a flexible terminal of the floating connector according to another preferred embodiment of the present invention.

FIG. 11 is a perspective view showing the connection of a female part of the floating connector according to the preferred embodiment of the present invention.

FIG. 12 is a perspective view showing the connection of a female part of the floating connector according to another preferred embodiment of the present invention.

FIG. 13 is a flow chart of connecting the floating connector according to the present invention.

### DETAILED DESCRIPTION

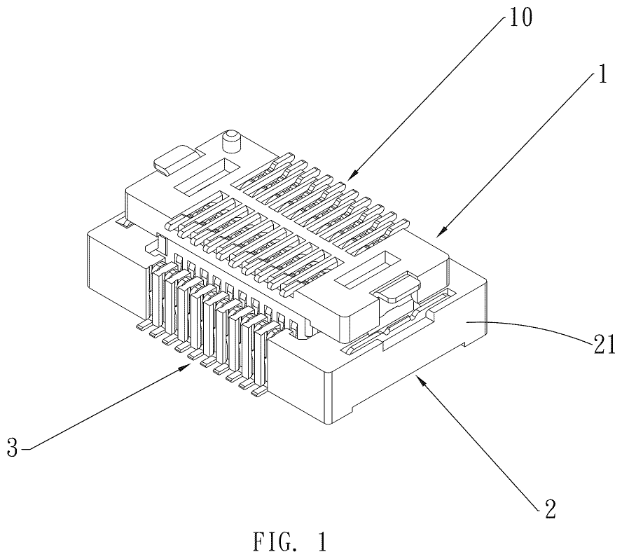

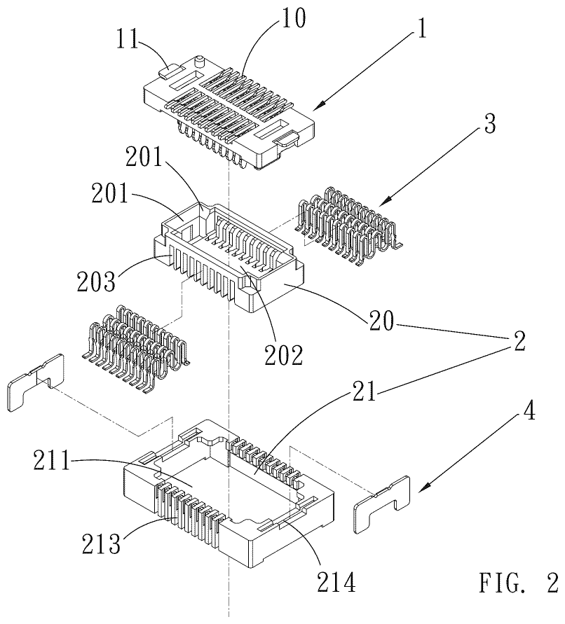

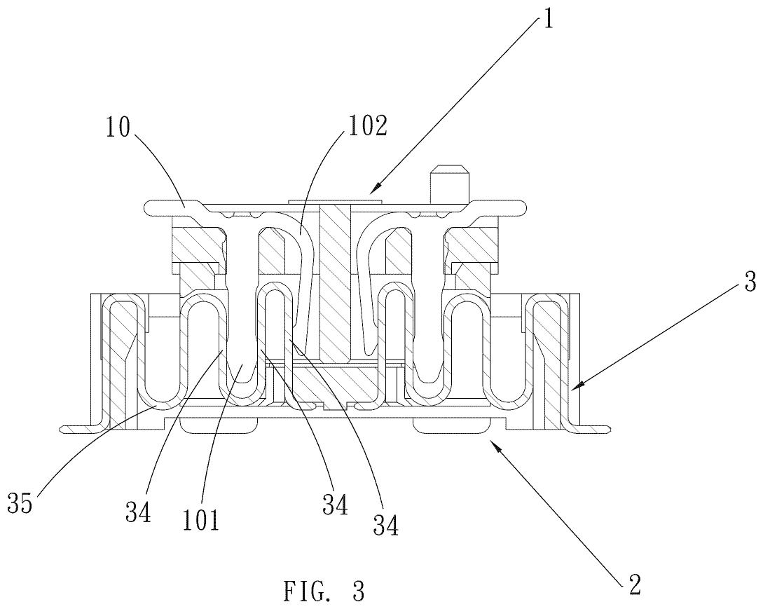

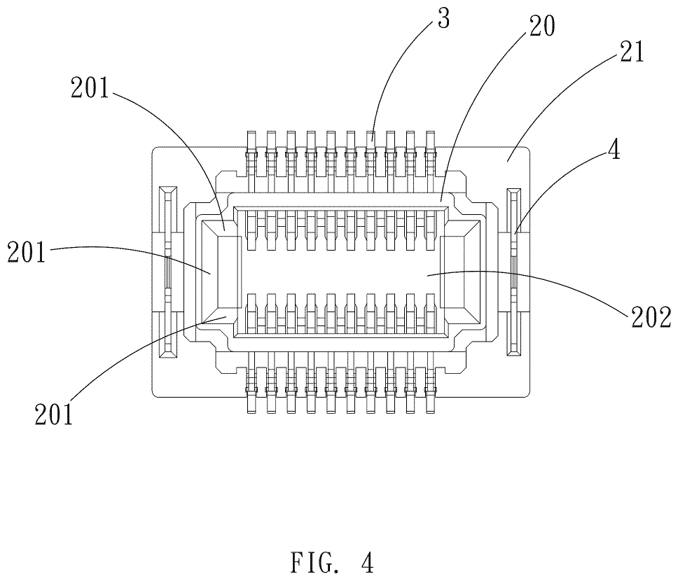

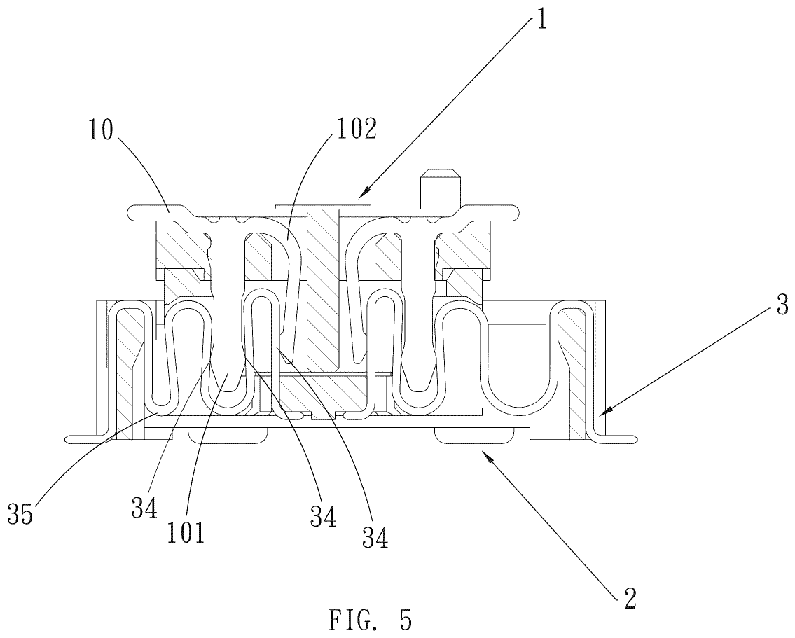

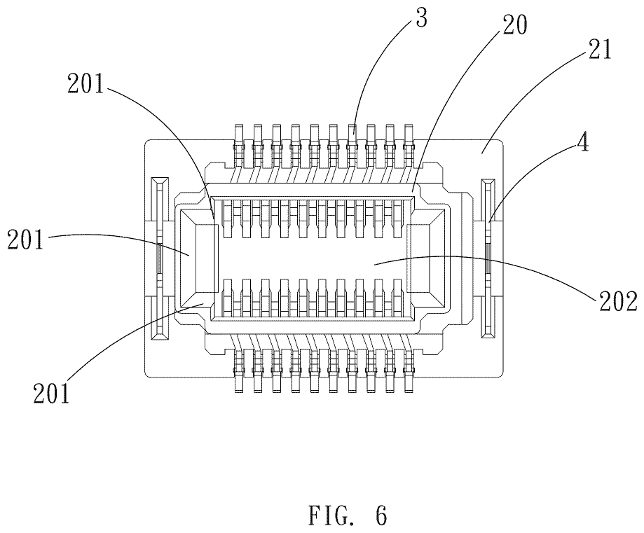

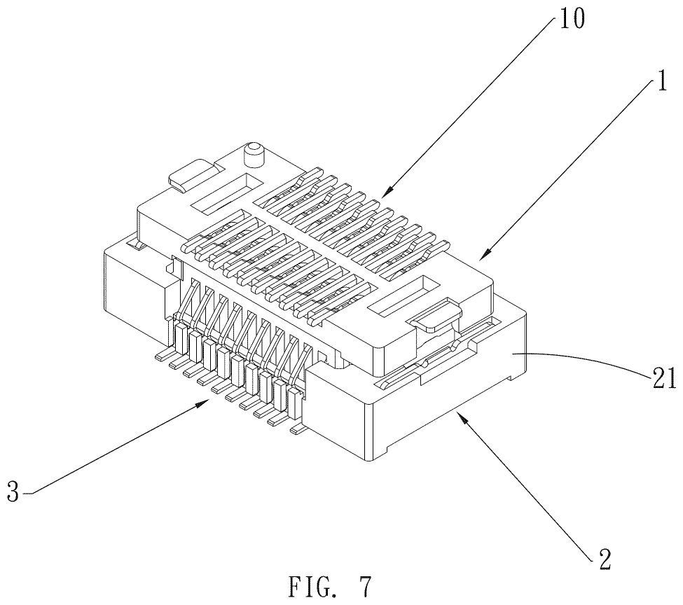

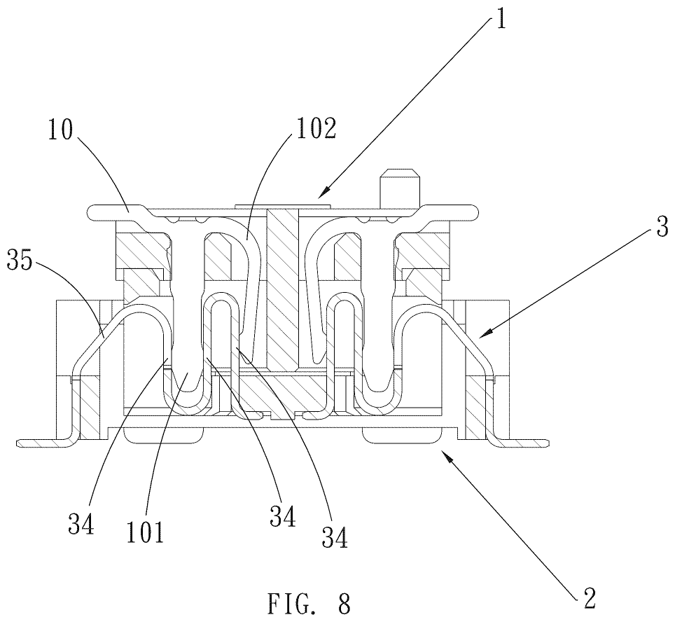

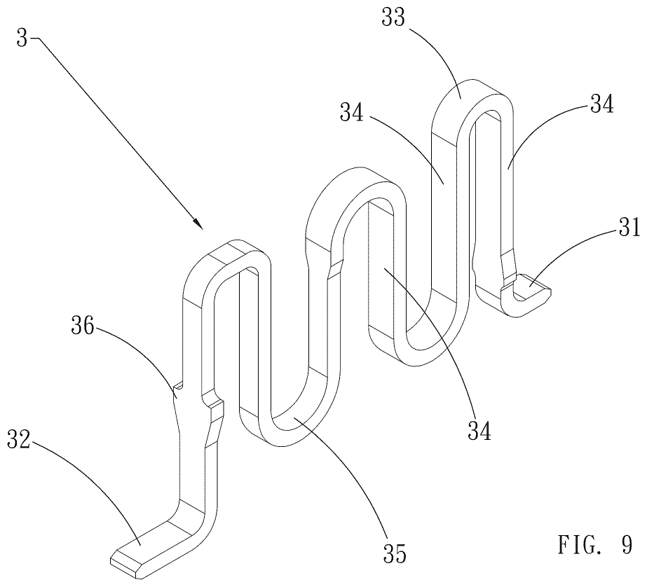

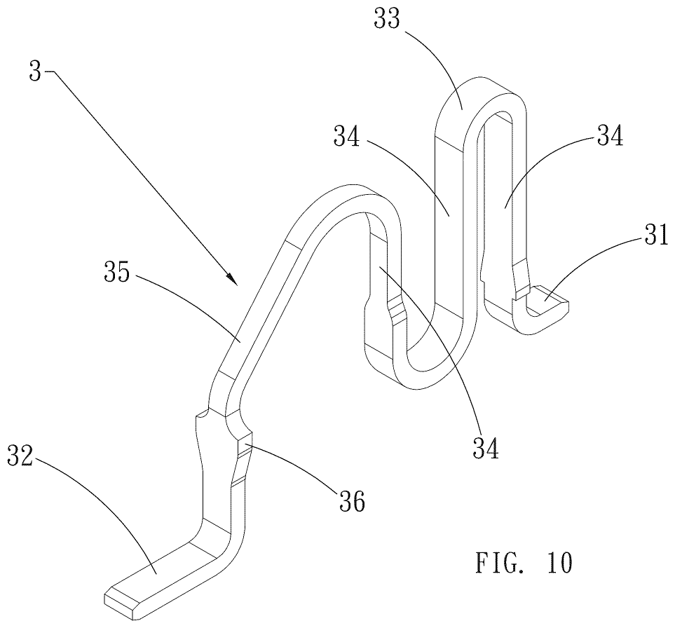

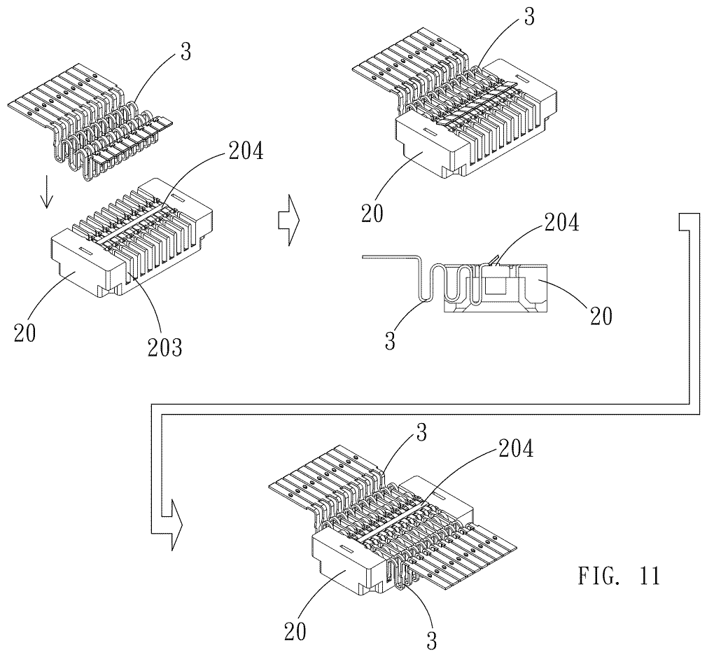

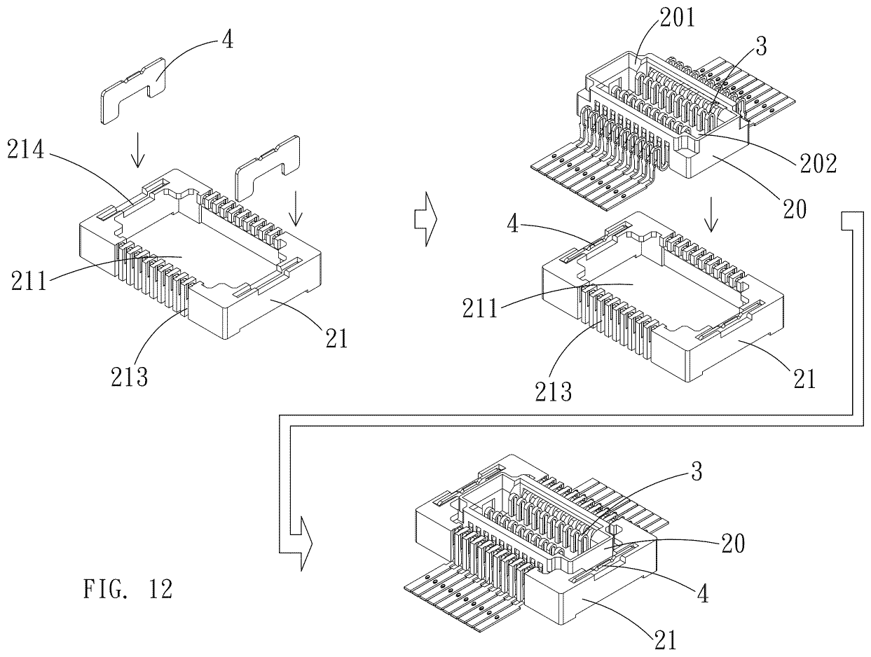

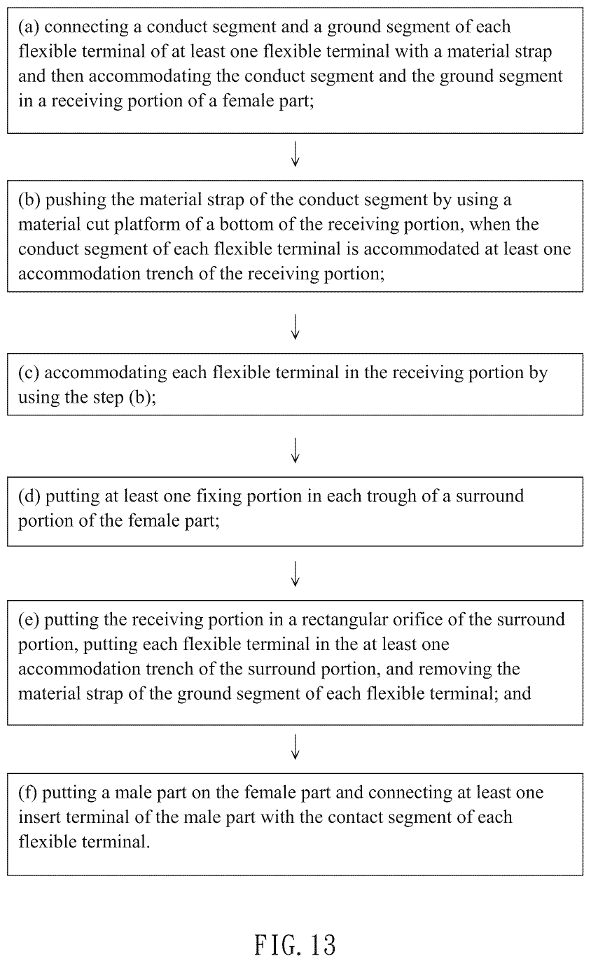

With reference to FIGS. 1-13, a floating connector according to a preferred embodiment of the present invention comprises: a male part 1, a female part 2, at least one flexible terminal 3, and at least one fixing portion 4. The male part 1 includes at least one insert terminal 10 connected on a central portion thereof, two fixed terminals 11 connected on two sides of the male part 1. The female part 2 includes a receiving portion 20 and a surround portion 21, wherein the receiving portion 20 is rectangular and has a guide groove 201 which is tilted and is formed at a predetermined position of the receiving portion 20, a recessed portion 202 defined on a predetermined position of a middle of the receiving portion 20, and at least one accommodation trench A203 formed on a long side of two long sides of the receiving portion 20. The surround portion 21 is rectangular and a size of the surround portion 21 is greater than a size of the receiving portion 20, wherein the surround portion 21 has a rectangular orifice 211 defined on a middle thereof, at least one accommodation trench 213 formed on two long sides of the surround portion 21, and at least one trough 214 defined on two short sides of the surround portion 21. The receiving portion 20 is located at the rectangular orifice 211 of the surround portion 21, and the at least one accommodation trench A203 of the receiving portion 20 corresponds to the at least one accommodation trench B213 of the surround portion 21, wherein a number of the at least one accommodation trench A203 of the receiving portion 20 is identical to a number of the at least one accommodation trench B213 of the surround portion 21. Each of the at least one flexible terminal 3 includes a conduct segment 31 formed on an end of each flexible terminal 3, a ground segment 32 formed on the other end of each flexible terminal 3, at least one bent section 33, and at least one contact section 34 formed at a predetermined position of each flexible terminal 3. Each flexible terminal 3 is received in the female part 3, each accommodation trench A203 of the receiving portion 20 and each accommodation trench B213 of the surround portion 21, wherein the conduct segment 31 of each flexible terminal 3 is accommodated in the recessed portion 202 of the receiving portion 20, and the ground segment 32 protrudes out of the surround portion 21. The male part 1 is inserted into the female part 2, each insert terminal 10 of the male part 1 is electrically connected with the contact section 34 of each flexible terminal 3, and each fixing portion 4 is received in each trough 214 of the female part 2.

Each insert terminal 10 of the male part 1 has a first coupling section A101 and a second coupling section B102. The receiving portion 20 of the female part 2 has a material cut platform 204 formed on a bottom of the receiving portion 20, the guide groove 201 is defined at a predetermined position of an X axis and a Y axis of the female part 2, and a number of the guide groove 201 of the female part 2 is plural. Each flexible terminal 3 includes a dislocation section 35 formed at a predetermined position thereof and two engagement tabs 36 extending from two side of each flexible terminal 3. Each fixing portion 4 is formed in a sheet shape.

In use, the male part 1 mates with the female part 2 by using each insert terminal 10 of the male part 1 and each flexible terminal 3 in the female part 2, such that a three-point contact is defined by the first coupling section A101 and the second coupling section B102 of each insert terminal 10 and each flexible terminal 3. In addition, the male part 1 moves in an X axis, a Y axis and a Z axis by way of each flexible terminal 3, thus obtaining a suspension effect.

In another embodiment, the dislocation section 35 of each flexible terminal 3 is in a U shape. In another embodiment, the dislocation section 35 of each flexible terminal 3 is tilted and has a higher inner wall and a low outer wall so as to be received in each accommodation trench B213 of the female part 2, such that each flexible terminal 3 is suspended.

When the male part 1 is simultaneously suspended, each insert terminal 10 of the male part 1 is in an electrical connection so as to be dislocated during a connection processing or in the use, thus avoiding a short circuit. Since the guide groove 201 is defined on the X axis and the Y axis of the female part 2, the male part 1 and the female part 2 mate smoothly when a dislocation occurs in the connection processing. Preferably, two engagement tabs 36 of each flexible terminal 3 mate with each accommodation trench B213 of the female part 2 stably to obtain easy replacement, save the connection process and cost and enhance a transmission efficiency and stability.

A method of connecting the floating connector has steps of:
(a) connecting the conduct segment and the ground segment of each flexible terminal with a material strap and then accommodating the conduct segment and the ground segment in the receiving portion;
(b) pushing the material strap of the conduct segment by using the material cut platform of the bottom of the receiving portion, when the conduct segment of each flexible terminal is accommodated the at least one accommodation trench of the receiving portion;
(c) accommodating each flexible terminal in the receiving portion by using the step (b);
(d) putting the at least one fixing portion in each trough of the surround portion;
(e) putting the receiving portion in the rectangular orifice of the surround portion, putting each flexible terminal in the at least one accommodation trench of the surround portion, and removing the material strap of the ground segment of each flexible terminal; and
(f) putting the male part on the female part and connecting the at least one insert terminal of the male part with the contact segment of each flexible terminal.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A floating connector comprising: a male part, a female part, at least one flexible terminal, and at least one fixing portion;
wherein the male part includes at least one insert terminal connected on a central portion thereof, and the male part includes two fixed terminals connected on two sides of the male part;
wherein the female part includes a receiving portion and a surround portion, the receiving portion is rectangular and has a guide groove which is tilted and is formed at a predetermined position of the receiving portion, a recessed portion defined on a predetermined position of a middle of the receiving portion, and at least one accommodation trench formed on a long side of two long sides of the receiving portion, wherein the surround portion is rectangular and a size of the surround portion is greater than a size of the receiving portion, the surround portion has a rectangular orifice defined on a middle thereof, and the surround portion has at least one accommodation trench formed on two long sides of the surround portion, and at least one trough defined on two short sides of the surround portion;
wherein the receiving portion is located at the rectangular orifice of the surround portion, the at least one accommodation trench of the receiving portion corresponds to the at least one accommodation trench of the surround portion, and a number of the at least one accommodation trench of the receiving portion is identical to a number of the at least one accommodation trench of the surround portion;
wherein each of the at least one flexible terminal includes a conduct segment formed on an end of each flexible terminal, a ground segment formed on the other end of each flexible terminal, at least one bent section, and at least one contact section formed at a predetermined position of each flexible terminal;
wherein each flexible terminal is received in the female part, each accommodation trench of the receiving portion and each accommodation trench of the surround portion, wherein the conduct segment of each flexible terminal is accommodated in the recessed portion of the receiving portion, and the ground segment protrudes out of the surround portion, wherein the male part is inserted into the female part, each insert terminal of the male part is electrically connected with the at least one contact section of each flexible terminal, and each fixing portion is received in each trough of the female part.

2. The floating connector as claimed in claim 1, wherein each insert terminal of the male part has a first coupling section and a second coupling section which are connected with the at least one contact section of the female part to produce a three-point contact.

3. The floating connector as claimed in claim 1, wherein the guide groove of the female part is defined at a predetermined position of an X axis and a Y axis of the female part.

4. The floating connector as claimed in claim 1, wherein the receiving portion of the female part has a material cut platform formed on a bottom of the receiving portion.

5. The floating connector as claimed in claim 1, wherein a number of the guide groove of the female part is plural.

6. The floating connector as claimed in claim 1, wherein each flexible terminal includes a dislocation section two engagement tabs extending from two side of each flexible terminal to enhance a fixing effect among the at least one accommodation trench of the surround portion of the female part.

7. The floating connector as claimed in claim 1, wherein each flexible terminal includes a dislocation section formed at a predetermined position thereof.

8. The floating connector as claimed in claim 1, wherein the dislocation section of each flexible terminal is in a U shape or the dislocation section of each flexible terminal is tilted and has a higher inner wall and a low outer wall.

9. The floating connector as claimed in claim 1, wherein each fixing portion is formed in a sheet shape.

10. A method of connecting the floating connector has steps of:
(a) connecting a conduct segment and a ground segment of each flexible terminal of at least one flexible terminal with a material strap and then accommodating the conduct segment and the ground segment in a receiving portion of a female part;
(b) pushing the material strap of the conduct segment by using a material cut platform of a bottom of the receiving portion, when the conduct segment of each flexible terminal is accommodated at least one accommodation trench of the receiving portion;
(c) accommodating each flexible terminal in the receiving portion by using the step (b);
(d) putting at least one fixing portion in each trough of a surround portion of the female part;
(e) putting the receiving portion in a rectangular orifice of the surround portion, putting each flexible terminal in the at least one accommodation trench of the surround portion, and removing the material strap of the ground segment of each flexible terminal; and
(f) putting a male part on the female part and connecting at least one insert terminal of the male part with the contact segment of each flexible terminal.
